(19) United States
(12) Patent Application Publication
(10) Pub. No.: US 2026/0135050 A1
(43) Pub. Date: May 14, 2026

(54) PUSH SWITCH DEVICE

(71) Applicant: Alps Alpine Co., Ltd., Tokyo (JP)

(72) Inventors: Dong ZHANG, WUXI (CN); Xunyu ZHANG, WUXI (CN)

(21) Appl. No.: 19/442,193

(22) Filed: Jan. 7, 2026

Related U.S. Application Data
(63) Continuation of application No. PCT/CN2024/108336, filed on Jul. 30, 2024.

(30) Foreign Application Priority Data
Aug. 1, 2023 (CN) 202310960812.X

(51) Int. Cl. H01H 13/04; H01H 13/52

(52) U.S. Cl. CPC H01H 13/04; H01H 13/52; H01H 2013/525

(57) ABSTRACT

A push switch device includes: an operating body having an operating portion for a pressing operation and being capable of moving up and down along a first direction; a follower having a through hole and being capable of rotating about an axis parallel to the first direction when the operating body moves up and down; a movable contact provided at a bottom of the follower; and a fixed contact provided in the housing and opposite to the movable contact. The follower has a linkage post protruding from a side wall of the through hole toward the part of the operating body, and the operating body has a guide portion configured to contact the linkage post, converting a pressing force along the first direction into a force along a circumferential direction about the axis to rotate the followers, thereby changing a contact position between the movable contact and the fixed contact.

### CLAIM OF PRIORITY

This application is a Continuation of International Application No. PCT/CN 2024/108336 filed on Jul. 30, 2024, which claims benefit of Chinese Patent Application No. 202310960812.X filed on Aug. 1, 2023. The entire contents of each application noted above are hereby incorporated by reference.

### BACKGROUND OF THE INVENTION

### 1. Field of the Invention

The present invention relates to a push switch device capable of causing a follower to rotate and perform a contact-switching operation when a pressing operation is applied to an operating body, and particularly to a push switch device in which the operating body is alternately held at different height positions when the pressing operation is repeatedly performed.

### 2. Description of the Related Art

In push switch devices according to the related art, the number of components tends to be large. For example, the push switch device disclosed in Chinese Patent Application Publication No. CN 101377982 A includes 11 components, namely a housing, an operating body, a cam follower, an elastic component, an actuating component, a return spring, a thin plate, a mounting plate, a movable contact, a fixed contact, and an anti-disengagement portion (an annular component). In this device, an interior of the housing has a hollow structure; the operating body can move up and down along an axial direction (up-and-down direction); the cam follower can move up and down along the axial direction in association with the up-and-down movement of the operating body and can also rotate along a circumferential direction; the elastic component is sandwiched between the operating body and the cam follower; the actuating component is spline-fitted to the cam follower so as to rotate integrally; the return spring is sandwiched between the cam follower and the actuating component; the thin plate rotatably supports the actuating component and covers a lower opening of the housing; and the mounting plate is mounted so as to hold the housing and the thin plate.

However, such a push switch device not only has a large number of components, but also exhibits complicated interconnections among the components, resulting in multiple processes required to assemble the device, high manufacturing cost, and low assembly efficiency.

### SUMMARY OF THE INVENTION

In view of this, the present invention is made and provides a push switch device having a simple structure and capable of continuously performing press-and-rotate operations.

A push switch device according to the present invention includes: an operating body having an operating portion for a pressing operation and being capable of moving up and down along a first direction when the pressing operation is performed; a follower having a through hole into which a part of the operating body is inserted and being capable of rotating about an axis parallel to the first direction when the operating body moves up and down; a housing accommodating the follower and the part of the operating body; a return spring provided between the housing and the operating body and configured to apply a restoring force to the operating body in a direction opposite to the pressing operation; a movable contact provided at a bottom of the follower; and a fixed contact provided in the housing and opposite to the movable contact. The follower has a linkage post protruding from a side wall of the through hole toward the part of the operating body, the operating body has a guide portion configured to contact the linkage post when the operating body moves up and down along the first direction, and the contact between the linkage post and the guide portion converts a pressing force along the first direction into a force along a circumferential direction about the axis to rotate the follower about the axis, thereby changing a contact position between the movable contact and the fixed contact.

### BRIEF DESCRIPTION OF THE DRAWINGS

FIG. 1 is a front view of a push switch device according to an embodiment of the present invention;

FIG. 2 is a perspective view of the push switch device as viewed obliquely from above;

FIG. 3 is a perspective view of the push switch device as viewed obliquely from below;

FIG. 4 is an exploded perspective view of the push switch device;

FIG. 5 is a perspective view of a movable contact and a fixed contact;

FIG. 6 is a top view of an operating body;

FIG. 7 is a top view of a follower;

FIG. 8 is a perspective view of a part of the follower;

FIG. 9 is a front view of the follower;

FIG. 10 is a front view of the operating body;

FIG. 11 is a perspective view of a housing;

FIG. 12 is a top view of the housing;

FIG. 13 is a diagram showing a relative positional relationship between the operating body and the follower in a first state;

FIG. 14 is a bottom view of the operating body and the follower in the first state;

FIG. 15 is a front view of the push switch device in a second state;

FIG. 16 is a diagram showing a relative positional relationship between the operating body and the follower in the second state;

FIG. 17 is a front view of the push switch device in a third state;

FIG. 18 is a diagram showing a relative positional relationship between the operating body and the follower in the third state;

FIG. 19 is a front view showing relative positions of the movable contact and the fixed contact in the first state;

FIG. 20 is a top view showing relative positions of the movable contact and the fixed contact in the first state;

FIG. 21 is a front view showing relative positions of the movable contact and the fixed contact in the third state; and

FIG. 22 is a top view showing relative positions of the movable contact and the fixed contact in the third state.

### DESCRIPTION OF THE PREFERRED EMBODIMENTS

The overall structure of a push switch device 1 according to an embodiment of the present invention will be described below.

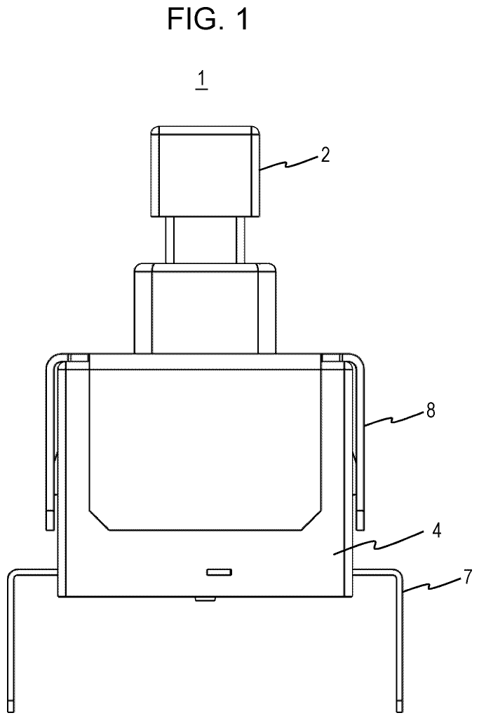

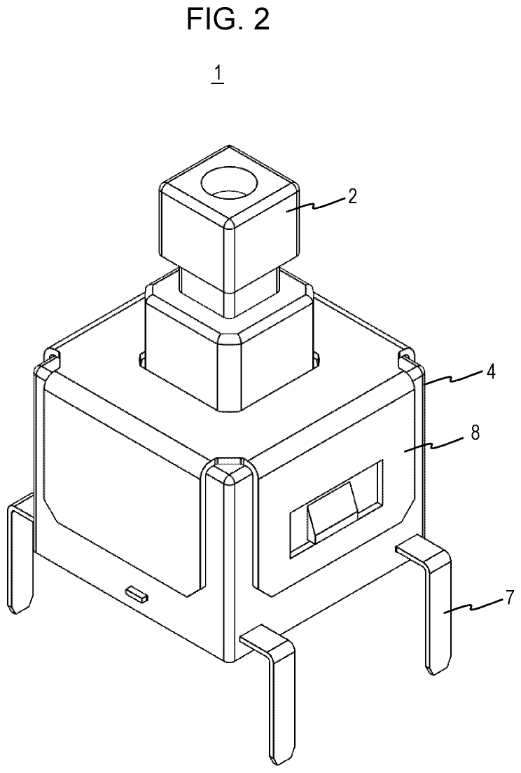

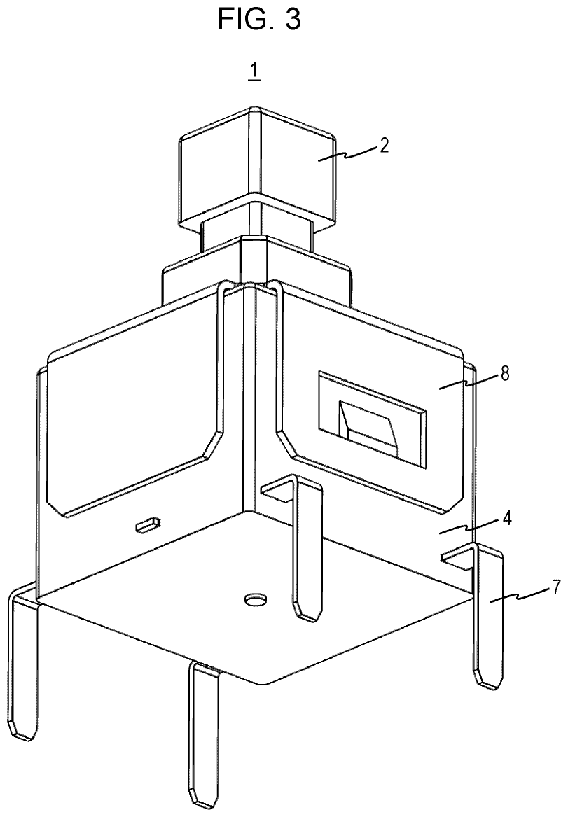

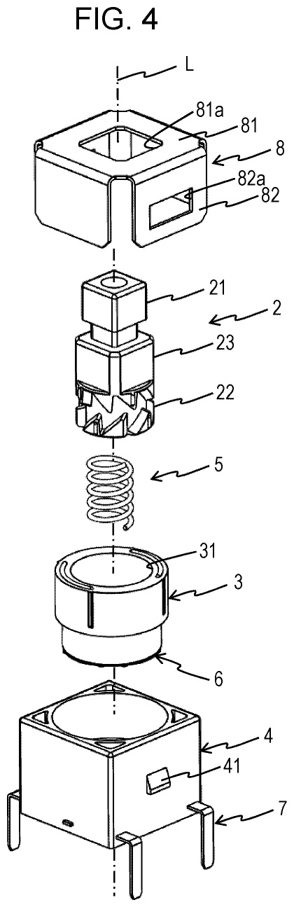

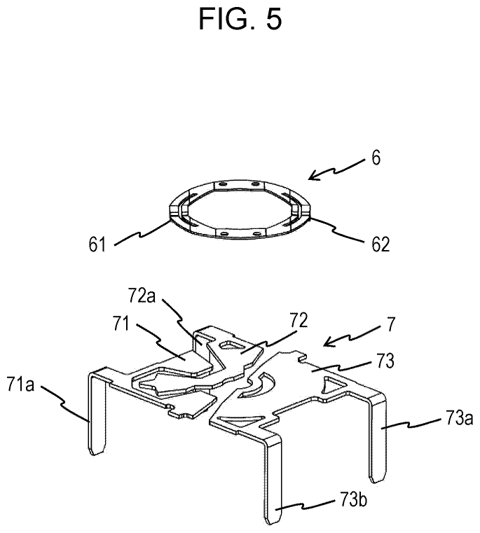

FIG. 1 is a front view of the push switch device 1 according to the embodiment of the present invention. FIG. 2 is a perspective view of the push switch device 1 as viewed obliquely from above. FIG. 3 is a perspective view of the push switch device 1 as viewed obliquely from below. FIG. 4 is an exploded perspective view of the push switch device 1. FIG. 5 is a perspective view of a movable contact 6 and a fixed contact 7 shown in FIG. 4. The configuration shown in FIGS. 1 to 5 corresponds to the positions of respective components in a first state (free state) where no pressing operation is applied to the push switch device 1.

As shown in FIGS. 1 to 5, the push switch device 1 of the present invention includes an operating body 2, a follower 3, a housing 4, a return spring 5, the movable contact 6, the fixed contact 7, and a cover body 8.

The operating body 2 is formed from a synthetic resin material. As shown in FIG. 4, the operating body 2 has an operating portion 21 for a pressing operation and may move along an up-and-down direction (a first direction) when the operating portion 21 is pressed downward. In addition, as shown in FIG. 4, the operating body 2 is further provided with a guide portion 22 configured to guide rotation of the follower 3 and a connecting portion 23 located between the operating portion 21 and the guide portion 22.

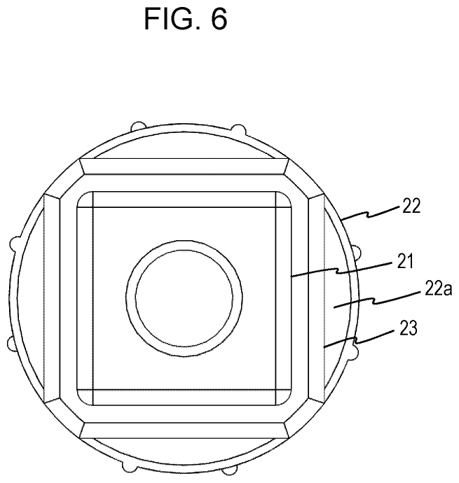

FIG. 6 is a top view of the operating body 2. In the top view, the operating portion 21 has a substantially square shape; the connecting portion 23 has a substantially square shape with its four corners chamfered into arcs and its side length greater than that of the operating portion 21; and the guide portion 22 has a substantially circular shape, with its circular outer periphery coinciding with an outer periphery of the chamfered arcs of the connecting portion 23.

The follower 3 is formed from a synthetic resin material having excellent sliding properties. As shown in FIG. 4, the follower 3 has a through hole 31 into which a part of the operating body 2 is inserted and may rotate about an axis L parallel to the up-and-down direction when the operating body 2 moves up and down.

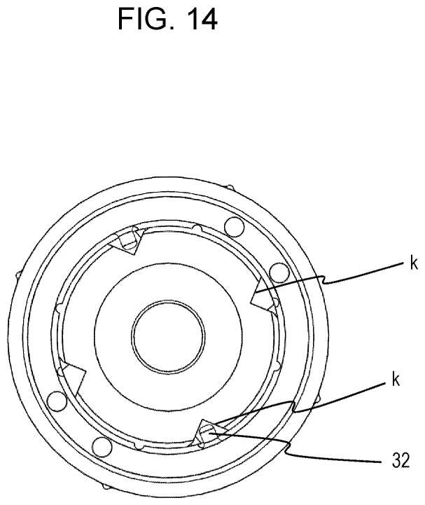

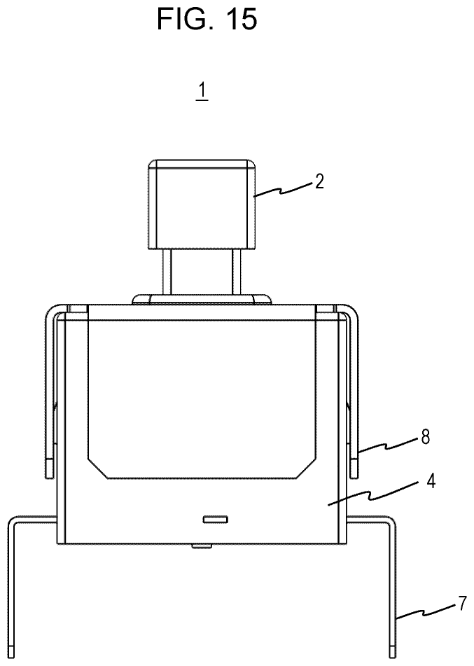

More specifically, in a state where no pressing operation is applied to the push switch device 1, the entire guide portion 22 is inserted into the through hole 31, while the connecting portion 23 is not inserted into the through hole 31 (see FIG. 1). During the process of applying a pressing operation to the push switch device 1, as the operating body 2 moves up and down, at least a part of the connecting portion 23 can enter the through hole 31 of the follower 3 (see FIG. 15).

The housing 4 is formed from a synthetic resin material and has a bottomed hollow shape. The housing 4 accommodates the follower 3 and the part of the operating body 2 received in the through hole 31.

The return spring 5 is a coil spring provided between the housing 4 and the operating body 2 and is configured to apply a restoring force to the operating body 2 in an upward direction (i.e., in a direction opposite to the pressing operation).

The movable contact 6 is provided at a bottom of the follower 3. As shown in FIGS. 4 and 5, the movable contact 6 is a substantially annular metal component fixed to the bottom of the follower 3, for example, by heat staking. The movable contact 6 has a first contact portion 61 and a second contact portion 62 protruding toward the fixed contact 7.

The fixed contact 7 is provided in the housing 4 in an insert-molding manner and is located at a position opposite to the movable contact 6. The fixed contact 7 is a metal component and, as shown in FIG. 5, includes a first fixed contact 71, a second fixed contact 72, and a third fixed contact 73. The first fixed contact 71 has a first external terminal 71a extending outward, the second fixed contact 72 has a second external terminal 72a extending outward, and the third fixed contact 73 has a third external terminal 73a and a fourth external terminal 73b extending outward.

The cover body 8 covers the housing 4. As shown in FIG. 4, the cover body 8 has a substantially square top surface 81 covering an upper surface of the housing 4, and an opening portion 81a is provided on the top surface 81. A part of the operating body 2 that is not inserted into the through hole 31 (the operating portion 21 and the connecting portion 23) is exposed through the opening portion 81a. In addition, as shown in FIG. 4, the cover body 8 is further provided with four side walls 82, each of which extends downward from four edges of the top surface 81, and at least one of the side walls 82 is formed with an engagement opening 82a. The engagement opening 82a engages with an engagement protrusion 41 formed on a side wall of the housing 4, thereby achieving relative fixation between the cover body 8 and the housing 4.

Further, a cross section of the connecting portion 23 of the operating body 2 is formed into a non-circular shape that is substantially identical to an opening shape of the opening portion 81a. For example, in this embodiment, the cross section of the connecting portion 23 and the opening shape of the opening portion 81a have a substantially identical square shape (see FIG. 6). The non-circular shape may alternatively be a triangular, pentagonal, hexagonal, or other polygonal shape. Such a structure can prevent the operating body 2 from rotating about the axis L.

Moreover, when no pressing operation is applied to the operating body 2, an upper surface 22a (see FIG. 6) of the guide portion 22 abuts, in the up-and-down direction, against a part of the top surface 81 of the cover body 8 located near the opening portion 81a, thereby defining a height of the part of the operating body 2 exposed from the cover body 8. Thus, when no pressing operation is applied to the operating body 2, the cover body 8 restricts the upward movement and disengagement of the operating body 2.

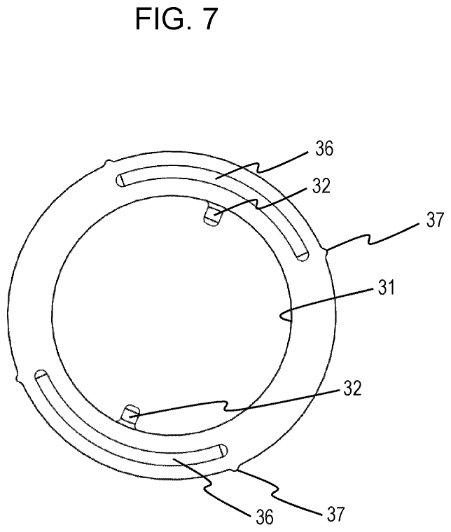

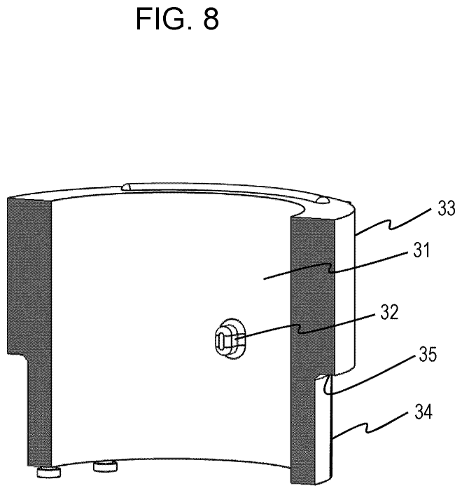

FIG. 7 is a top view of the follower 3. As shown in FIG. 7, the follower 3 has two linkage posts 32 protruding from a side wall of the through hole 31 toward a circle center. In an assembled state, the linkage posts 32 protrude from the side wall of the through hole 31 toward the inserted guide portion 22. FIG. 8 is a perspective view of a part of the follower 3. To facilitate observation of the shape of the linkage posts 32, a part of the follower 3 has been cut away along a plane parallel to the axis L in FIG. 8. As shown in FIG. 8, the linkage post 32 is a column having a cross section shaped like a running track, with straight sections of the track shape extending along the up-and-down direction and curved sections located at the upper and lower sides.

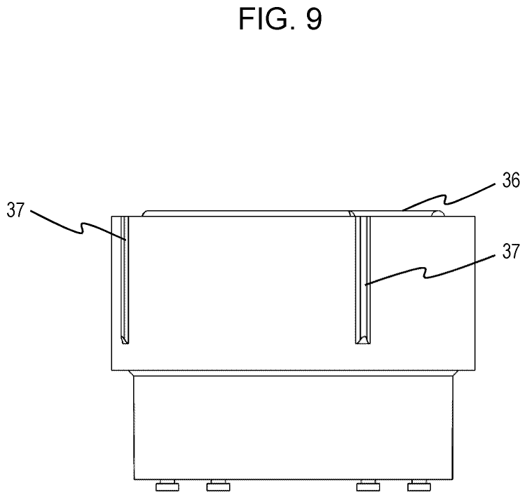

FIG. 9 is a front view of the follower 3. As shown in FIG. 7 and FIG. 9, two first protrusions 36 protruding upward are provided on an upper surface of the follower 3 in a substantially centrally symmetric manner as viewed from above, and each extend along a circumferential direction about the axis L. In addition, four second protrusions 37 protruding radially outward are provided on an outer side surface of the follower 3 in a substantially centrally symmetric manner as viewed from above, and each extend along the up-and-down direction parallel to the axis L.

The first protrusions 36 are configured to restrict wobbling of the follower 3 accommodated in the housing 4 along a direction of the axis L and reduce the contact area with the cover body 8 during rotation, thereby reducing frictional resistance. The second protrusions 37 are configured to restrict wobbling of the follower 3 in a plane perpendicular to the axis L and reduce the contact area with the housing 4 during rotation, thereby reducing frictional resistance.

During the process in which a pressing operation is applied to the push switch device 1, when the operating body 2 moves along the up-and-down direction, the guide portion 22 contacts the linkage posts 32, the contact between the the guide portion 22 and the linkage posts 32 converts a pressing force along the up-and-down direction into a force along the circumferential direction about the axis L to rotate the follower 3 about the axis L, thereby changing a contact position between the movable contact 6 and the fixed contact 7.

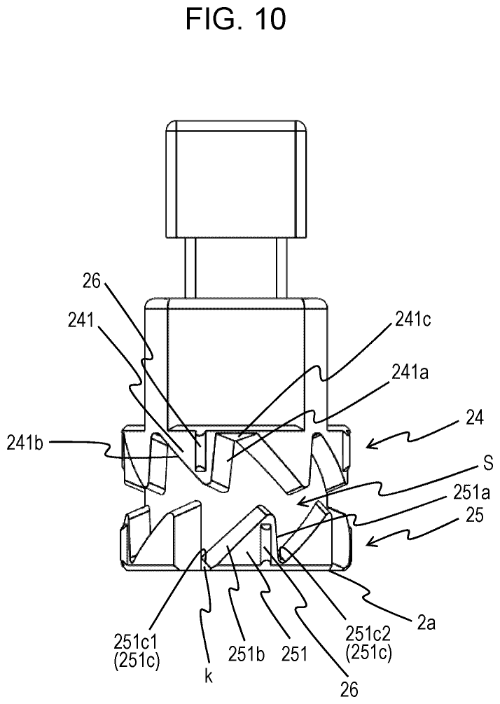

FIG. 10 is a front view of the operating body. As shown in FIG. 10, the guide portion 22 includes a first cam 24 and a second cam 25 provided on an outer side surface of the operating body 2 along the up-and-down direction. The first cam 24 is located on a side close to the operating portion 21 (upper side in FIG. 10) and has a plurality of upper teeth 241 arranged along the circumferential direction and protruding toward the fixed contact 7 (lower side in FIG. 10). The second cam 25 is located on a side close to the fixed contact 7 (lower side in FIG. 10) and has a plurality of lower teeth 251 arranged along the circumferential direction and protruding toward the operating portion 21 (upper side in FIG. 10). The plurality of upper teeth 241 and the plurality of lower teeth 251 are opposite to each other in a projection-recess corresponding manner, and a space S for accommodating the linkage post 32 is formed between the plurality of upper teeth 241 and the plurality of lower teeth 251.

As shown in FIG. 10, each of the upper teeth 241 has a first side 241a extending substantially along the up-and-down direction and a second side 241b extending along a second direction intersecting the up-and-down direction. Each of the lower teeth 251 has a third side 251a extending substantially along the up-and-down direction and a fourth side 251b extending along a third direction intersecting both the up-and-down direction and the second direction.

Further, the extending directions of the first side 241a and the third side 251a are not limited to those substantially along the up-and-down direction. When vertical spacing and horizontal spacing between the upper tooth 241 and the lower tooth 251 and a width dimension of the linkage post 32 vary, an angle between the extending direction of the first side 241a and the up-and-down direction changes, and likewise an angle between the extending direction of the third side 251a and the up-and-down direction also changes.

An upper tooth root 241c formed by upper end portions of the first side 241a and the second side 241b of the adjacent upper tooth 241 is opposite to a part of the fourth side 251b close to the upper tooth 241 along the up-and-down direction. A lower tooth root 251c formed by lower end portions of the third side 251a and the fourth side 251b of the adjacent lower tooth 251 is opposite to a part of the second side 241b close to the lower tooth 251 along the up-and-down direction.

Further, the lower tooth root 251c of the second cam 25 includes a plurality of lower tooth roots 251c1, the plurality of lower tooth roots 251c include a first lower tooth root 251c1 and a second lower tooth root 251c2, the first lower tooth root 251c1 has an opening k provided between the third side 251a and the fourth side 251b, the second lower tooth root 251c2 is formed by connection of the third side 251a and the fourth side 251b, and the first lower tooth root 251c1 and the second lower tooth root 251c2 are alternately arranged in the circumferential direction.

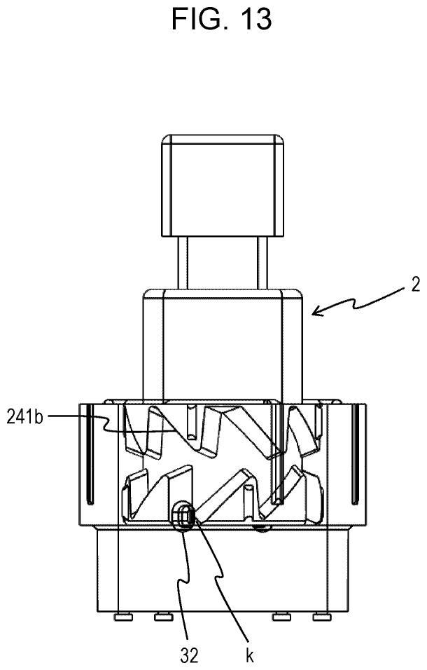

The opening k of the first lower tooth root 251c1 is configured to have a width that allows the linkage post 32 to pass therethrough along the up-and-down direction (see FIG. 14). During assembly, the first lower tooth root 251c1 functions as an entrance through which the linkage post 32 is inserted between the upper tooth 241 and the lower tooth 251.

Further, eight third protrusions 26 protruding radially outward are provided on outer side surfaces of the first cam 24 and the second cam 25, where four third protrusions 26 are provided on an outer side surface of the upper teeth 241, and four third protrusions 26 are provided on an outer side surface of the lower teeth 251. The plurality of third protrusions 26 are arranged substantially evenly along the circumferential direction as viewed from above, and each extend along a direction parallel to the axis L.

The third protrusions 26 are configured to restrict wobbling of the operating body 2 in the plane perpendicular to the axis L and reduce the contact area with the follower 3 during rotation, thereby reducing frictional resistance.

As shown in FIG. 8, the follower 3 is divided into an upper portion 33 close to the operating portion 21 and a lower portion 34 to which the movable contact 6 is fixed. An outer diameter of the upper portion 33 is greater than that of the lower portion 34, and an annular stepped surface 35 having a step is formed between an outer side wall of the upper portion 33 and an outer side wall of the lower portion 34.

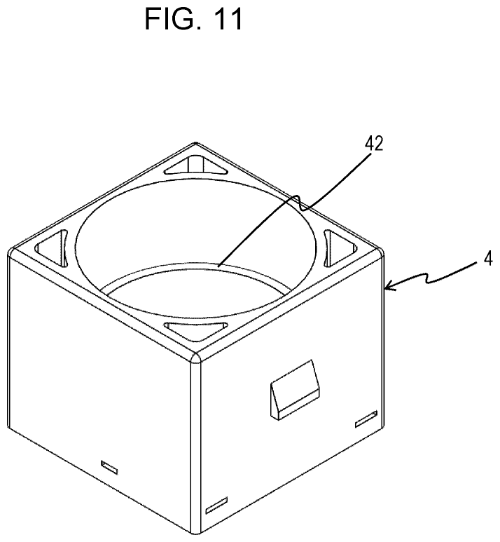

FIG. 11 is a perspective view of the housing 4. FIG. 12 is a top view of the housing 4. As shown in FIGS. 11 and 12, an inner side wall of the housing 4 has a stopper surface 42 opposite to the stepped surface 35 of the follower 3 and configured to restrict movement of the follower 3 toward a bottom side of the housing 4. Thus, a lower limit for the follower 3 is achieved with a simple structure.

Next, the pressing operation process of the push switch device 1 will be described.

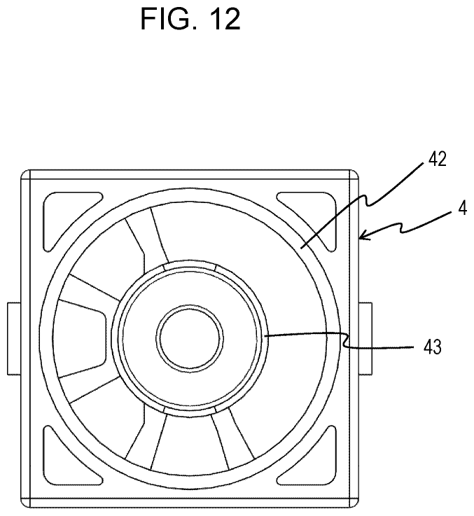

FIG. 1 shows the first state of the push switch device 1 where no pressing operation is applied to the operating body 2. FIG. 13 is a diagram showing a relative positional relationship between the operating body 2 and the follower 3 in the first state. FIG. 14 is a bottom view of the operating body and the follower in the first state. For ease of explanation, only the operating body 2 and the follower 3 are shown in FIGS. 13 and 14, and the follower 3 in FIG. 13 is shown in a transparent state.

As shown in FIGS. 13 and 14, in the first state, the linkage post 32 is located at the opening k of the first lower tooth root 251c1.

When the operating body 2 is pressed, the operating body 2 moves downward, and the distance between the second side 241b and the linkage post 32 gradually decreases and they come into contact with each other. After contact, while the operating body 2 continues to move downward, the pressing force along the up-and-down direction is converted into the force that causes the follower 3 to rotate along the circumferential direction about the axis L, whereby the follower 3 begins to rotate along the clockwise circumferential direction as viewed from above.

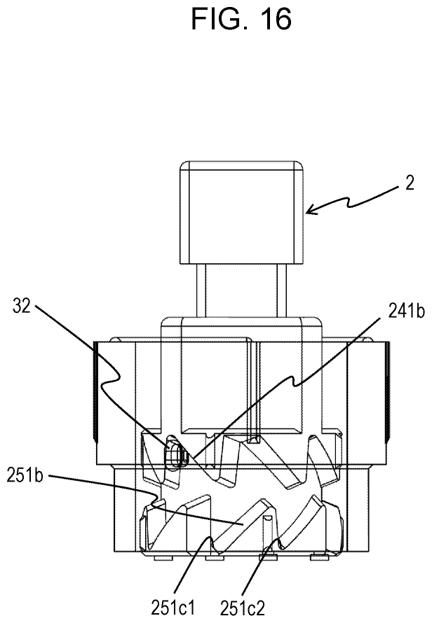

When a bottom surface 2a of the operating body 2 (see FIG. 10) comes into contact with a bottom protruding ring 43 (see FIG. 12) of the housing 4, the push switch device 1 enters a second state (fully-pressed state), and the rotation of the follower 3 stops. FIG. 15 is a front view of the push switch device 1 in the second state. FIG. 16 is a diagram showing the relative positional relationship between the operating body 2 and the follower 3 in the second state.

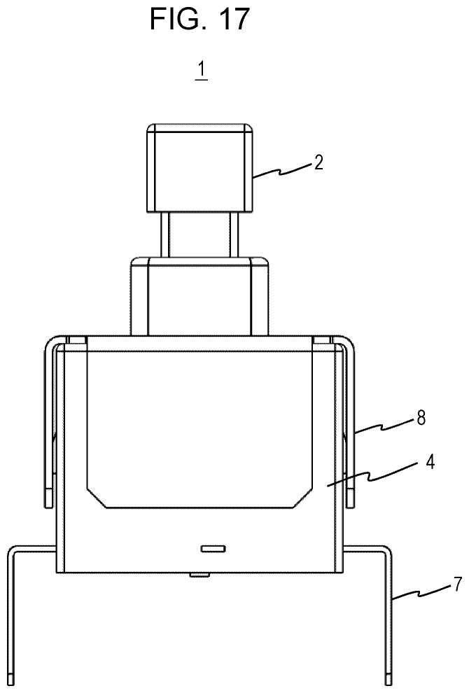

In the second state, when the application of the pressing force to the operating body 2 is stopped, the operating body 2 moves upward based on the restoring force of the return spring 5, and the distance between the fourth side 251b and the linkage post 32 gradually decreases and they come into contact with each other. After contact, while the operating body 2 continues to move upward, the restoring force along the up-and-down direction provided by the return spring 5 is converted into the force that causes the follower 3 to rotate along the circumferential direction about the axis L, whereby the follower 3 begins to rotate again along the clockwise circumferential direction as viewed from above. When the linkage post 32 is located at the second lower tooth root 251c2 adjacent to the first lower tooth root 251c1 along a rotational direction of the follower 3, the push switch device 1 enters a third state (latched state), and the rotation of the follower 3 stops. FIG. 17 is a front view of the push switch device 1 in the third state. FIG. 18 is a diagram showing the relative positional relationship between the operating body 2 and the follower 3 in the third state.

When the operating body 2 is pressed in the third state, the operating body 2 moves downward, and the distance between the second side 241b and the linkage post 32 gradually decreases and they come into contact with each other. When the bottom surface 2a of the operating body 2 comes into contact with the bottom protruding ring 43 (see FIG. 12) of the housing 4, the push switch device 1 returns to the above second state, and the rotation of the follower 3 stops.

Next, in the second state, when the application of the pressing force to the operating body 2 is stopped, the operating body 2 moves upward based on the restoring force of the return spring 5, and the distance between the fourth side 251b and the linkage post 32 gradually decreases and they come into contact with each other. After contact, while the operating body 2 continues to move upward, the restoring force along the up-and-down direction provided by the return spring 5 is converted into the force that causes the follower 3 to rotate along the circumferential direction about the axis L, whereby the follower 3 begins to rotate again along the clockwise circumferential direction as viewed from above. When the linkage post 32 is located at the first lower tooth root 251c1 adjacent to the second lower tooth root 251c2 along the rotational direction of the follower 3 in the third state, the push switch device 1 returns to the first state, and the rotation of the follower 3 stops.

Further, as shown in FIG. 1 and FIG. 17, a height of the operating body 2 in the first state is slightly greater than that in the third state. In other words, in the first state, the part of the connecting portion 23 exposed from the cover body 8 is larger than that in the third state. This is because, when the linkage post 32 is located at the second lower tooth root 251c2 in the third state, their contact restricts the upward movement of the operating body 2. In contrast, when the linkage post 32 is located at the first lower tooth root 251c1 in the first state, the linkage post 32 is located in the opening k of the first lower tooth root 251c1, and in this case, the upward movement of the operating body 2 is not restricted. Since the height of the operating body 2 in the first state and in the third state differs, different operating states of the push switch device 1 can be identified based on the height of the operating body 2.

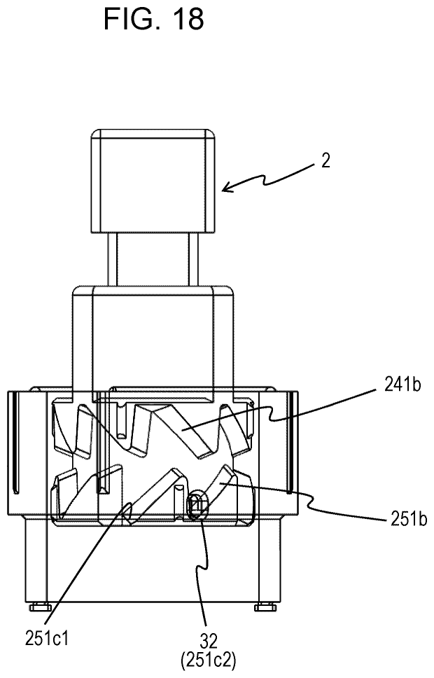

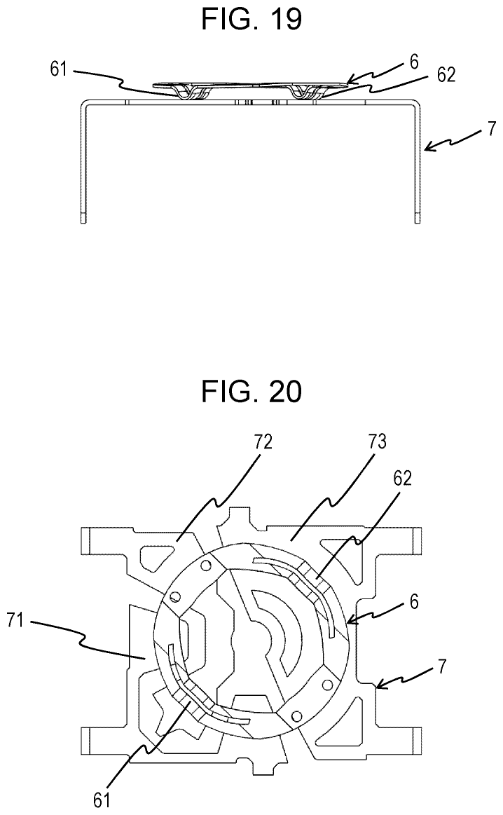

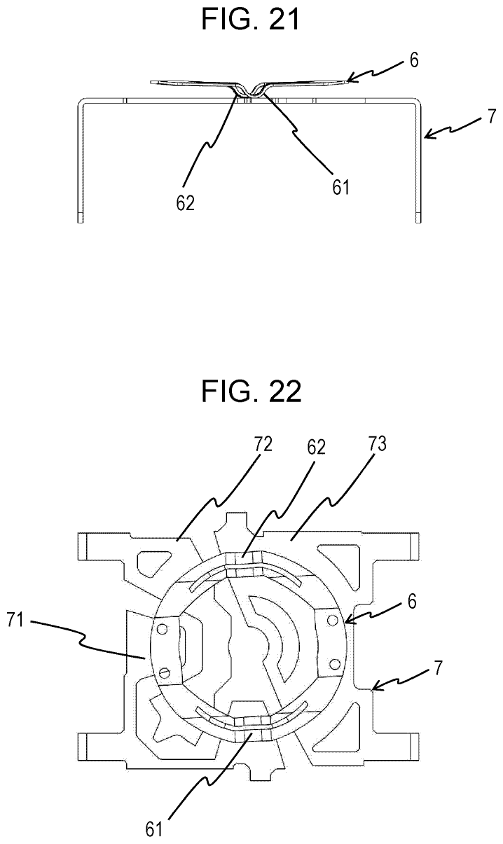

Next, referring to FIGS. 19 to 22, the different operating states of the push switch device 1 will be described. FIG. 19 is a front view showing relative positions of the movable contact 6 and the fixed contact 7 in the first state. FIG. 20 is a top view showing the relative positions of the movable contact 6 and the fixed contact 7 in the first state. FIG. 21 is a front view showing the relative positions of the movable contact 6 and the fixed contact 7 in the third state. FIG. 22 is a top view showing the relative positions of the movable contact 6 and the fixed contact 7 in the third state. For ease of explanation, only the movable contact 6 and the fixed contact 7 are shown in FIGS. 19 to 22, and other components are omitted.

As shown in FIGS. 19 and 20, in the first state, the first contact portion 61 is in contact with the second fixed contact 72 of the fixed contact 7, and the second contact portion 62 is in contact with the third fixed contact 73 of the fixed contact 7. In addition, FIGS. 19 and 20 only show one example of the first contact portion 61 and the second contact portion 62 contacting the fixed contact 7 in the first state. As the follower 3 continues to rotate, the first contact portion 61 may also contact other portions of the second fixed contact 72, while the second contact portion 62 contacts the third fixed contact 73 of the fixed contact 7. Furthermore, as the follower 3 continues to rotate, the first contact portion 61 may also contact the third fixed contact 73, while the second contact portion 62 contacts the second fixed contact 72 of the fixed contact 7. In short, in the first state, it is only necessary that the second fixed contact 72 and the third fixed contact 73 of the fixed contact 7 be electrically connected through the movable contact 6.

As shown in FIGS. 21 and 22, in the third state, the first contact portion 61 is in contact with the first fixed contact 71 of the fixed contact 7, and the second contact portion 62 is in contact with the third fixed contact 73 of the fixed contact 7. In addition, FIGS. 21 and 22 only show one example of the first contact portion 61 and the second contact portion 62 contacting the fixed contact 7 in the third state. As the follower 3 continues to rotate, the first contact portion 61 may also contact other portions of the first fixed contact 71, while the second contact portion 62 contacts the third fixed contact 73 of the fixed contact 7. Furthermore, as the follower 3 continues to rotate, the first contact portion 61 may also contact the third fixed contact 73, while the second contact portion 62 contacts the first fixed contact 71 of the fixed contact 7. In short, in the third state, it is only necessary that the first fixed contact 71 and the third fixed contact 73 of the fixed contact 7 be electrically connected through the movable contact 6.

Next, the technical effects of the push switch device 1 of the present invention will be described.

In the push switch device 1 of the present invention, continuous press-and-rotate operations can be realized merely by the guide portion 22 of the operating body 2 driving the linkage post 32 of the follower 3. Compared with push switch devices according to the related art, the number of components can be significantly reduced, the structures of the operating body 2 and the follower 3 are simplified, and the manufacturing cost of the components can be cut down. In addition, fewer assembly processes improve the assembly efficiency of the push switch device 1.

Further, in the above push switch device 1, the linkage posts 32 are provided between the plurality of upper teeth 241 of the first cam 24 and the plurality of lower teeth 251 of the second cam 25. When the pressing force is applied, the upper teeth 241 drive the follower 3 to rotate based on the pressing force, whereas when no pressing force is applied, the lower teeth 251 drive the follower 3 to rotate based on the restoring force of the return spring 5. In the present invention, both the first cam 24 and the second cam 25, which are configured to drive the rotation of the follower 3, are provided on the operating body 2. Compared with the case where the first cam and the second cam are provided on different components, assembly tolerances can be avoided, thereby ensuring the accuracy of the relative positions between the first cam 24 and the second cam 25, and improving the stability and smoothness of the pressing operation.

Since the upper tooth root 241c is opposite to the part of the fourth side 251b close to the upper tooth 241, and the lower tooth root 251c is opposite to the part of the second side 241b close to the lower tooth 251, continuous rotation of the follower 3 caused by the downward and upward movements of the operating body 2 can be achieved.

### Other Modifications

The above embodiments are merely examples, and the present invention is not limited thereto. For the above embodiments, a person skilled in the art may appropriately add, delete, or modify structural elements, or appropriately combine features of each embodiment, and all such modifications fall within the scope of the present invention so long as they embody the technical concept of the invention.

For example, in the above embodiments, the cross section of the connecting portion 23 of the operating body 2 located at the opening portion 81a is formed into a non-circular shape substantially identical to the opening shape of the opening portion 81a, but it is not limited thereto. For example, the cross section of the connecting portion 23 and the opening shape of the opening portion 81a may both be formed into a circular shape, and a specific shape allowing mutual engagement may be provided on both the connecting portion 23 and the opening portion 81a, whereby rotation of the operating body 2 about the axis L can also be prevented.

What is claimed is:

1. A push switch device, comprising:
an operating body having an operating portion for a pressing operation and being capable of moving up and down along a first direction when the pressing operation is performed;
a follower having a through hole into which a part of the operating body is inserted and being capable of rotating about an axis parallel to the first direction when the operating body moves up and down;
a housing accommodating the follower and the part of the operating body;
a return spring provided between the housing and the operating body and configured to apply a restoring force to the operating body in a direction opposite to the pressing operation;
a movable contact provided at a bottom of the follower; and
a fixed contact provided in the housing and opposite to the movable contact, wherein
the follower has a linkage post protruding from a side wall of the through hole toward the part of the operating body, the operating body has a guide portion configured to contact the linkage post when the operating body moves up and down along the first direction, and the contact between the linkage post and the guide portion converts a pressing force along the first direction into a force along a circumferential direction about the axis to rotate the follower about the axis, thereby changing a contact position between the movable contact and the fixed contact.

2. The push switch device according to claim 1, wherein
the guide portion comprises a first cam and a second cam provided on an outer side surface of the operating body along the first direction, the first cam is located on a side close to the operating portion and has a plurality of upper teeth arranged along the circumferential direction and protruding toward the fixed contact, the second cam is located on a side close to the fixed contact and has a plurality of lower teeth arranged along the circumferential direction and protruding toward the operating portion, and the plurality of upper teeth and the plurality of lower teeth are opposite to each other in a projection-recess corresponding manner, and a space for accommodating the linkage post is formed between the plurality of upper teeth and the plurality of lower teeth.

3. The push switch device according to claim 2, wherein
each of the upper teeth has a first side extending along the first direction and a second side extending along a second direction intersecting the first direction, and each of the lower teeth has a third side extending along the first direction and a fourth side extending along a third direction intersecting both the first direction and the second direction; and
an upper tooth root formed by end portions of the first side and the second side away from the lower teeth is opposite to a part of the fourth side close to the upper tooth along the first direction, and a lower tooth root formed by end portions of the third side and the fourth side away from the upper teeth is opposite to a part of the second side close to the lower tooth along the first direction.

4. The push switch device according to claim 3, wherein
the lower tooth root of the second cam comprises a plurality of lower tooth roots, the plurality of lower tooth roots comprises a first lower tooth root and a second lower tooth root, the first lower tooth root has an opening provided between the third side and the fourth side, the second lower tooth root is formed by connection of the third side and the fourth side, and the first lower tooth root and the second lower tooth root are alternately arranged in the circumferential direction; and
the opening of the first lower tooth root is configured to have a width that allows the linkage post to pass therethrough along the first direction.

5. The push switch device according to claim 4, wherein
in a first state where no pressing operation is applied to the operating body, the linkage post is located at the first lower tooth root;
when the operating body is pressed, the operating body moves downward, and the second side contacts the linkage post; and when a bottom surface of the operating body contacts the housing, the push switch device enters a second state;
in the second state, the operating body moves upward based on the restoring force of the return spring, and the fourth side contacts the linkage post; and when the linkage post is located at the second lower tooth root adjacent to the first lower tooth root along a rotational direction of the follower, the push switch device enters a third state;
when the operating body is pressed in the third state, the operating body moves downward, and the second side contacts the linkage post; and when the bottom surface of the operating body contacts the housing, the push switch device returns to the second state;
in the second state, the operating body moves upward based on the restoring force of the return spring, and the fourth side contacts the linkage post; and when the linkage post is located at the first lower tooth root adjacent to the second lower tooth root along the rotational direction of the follower, the push switch device returns to the first state; and
a height of the operating body in the first state is greater than that in the third state.

6. The push switch device according to claim 1, further comprising a cover body covering the housing, wherein an opening portion is provided on a top surface of the cover body, another part of the operating body that is not inserted into the through hole is exposed through the opening portion, and in a state where no pressing operation is applied to the operating body, the opening portion defines a height of the part of the operating body exposed from the cover body.

7. The push switch device according to claim 6, wherein
an opening shape of the opening portion and a cross-sectional shape of a part of the operating body located at the opening portion are formed into substantially identical non-circular shapes.

8. The push switch device according to claim 1, wherein
the follower is divided into an upper portion close to the operating portion and a lower portion to which the movable contact is fixed, an outer diameter of the upper portion is greater than that an outer diameter of the lower portion, and a stepped surface having a step is formed between an outer side wall of the upper portion and an outer side wall of the lower portion; and
an inner side wall of the housing has a stopper surface opposite to the stepped surface and configured to restrict movement of the follower toward a bottom side of the housing.

9. The push switch device according to claim 8, wherein
one or more first protrusions are provided on a top surface of the upper portion of the follower, the top surface facing the cover body; and
one or more second protrusions are provided on an outer side surface of the upper portion of the follower opposite to the housing.

10. The push switch device according to claim 2, wherein
a plurality of third protrusions protruding toward the follower are provided on outer side surfaces of the first cam and the second cam.
